(19) United States
(12) Patent Application Publication
(10) Pub. No.: US 2008/0294461 A1
(43) Pub. Date: Nov. 27, 2008

(54) Checking and Verifying Blood Screening Data

(75) Inventors: Timothy Monroe Prescott, Tucson, AZ (US); David Monroe Prescott, Tucson, AZ (US); Anna Clare Prescott, Tucson, AZ (US)

Correspondence Address: QUARLES & BRADY LLP, ONE SOUTH CHURCH AVENUE, SUITE 1700, TUCSON, AZ, 85701-1621, US

(73) Assignee: PRESCOTT IDEAS L.L.C., Tucson, AZ (US)

(21) Appl. No.: 11/751,145

(22) Filed: May 21, 2007

(51) Int. Cl. G06F 19/00

(52) U.S. Cl. 705/3

(57) ABSTRACT

A computer-implemented method verifies data from an electronic blood screen panel. Blood screening data is extracted from the electronic blood screen panel into a first data summary. The first data summary includes a lot number and expiration date, a donor number, and a number of negative reactions in each row and column in the panel. A user is queried to manually enter a second data summary. The second data summary includes the lot number and expiration date, the donor number, and the number of negative reactions in each row and column in the panel. The first and second data summaries are compared. A first security code is generated according to an algorithm based on current blood screening data incorporated into the first data summary. The first security code is appended to the electronic blood screen panel when the first and second data summaries match.

### FIELD OF THE INVENTION

The present invention relates in general to computers and medical devices and, more particularly, to a computerized system and method of checking and verifying blood screening data.

### BACKGROUND OF THE INVENTION

Trained medical technologists have long used a written, paper-based method of identifying unexpected antibodies in human blood. Antigens are normally found on the surface of red blood cells. Certain conditions can result in the production of antibodies to these antigens.

A “panel” or series of tests are used to screen blood samples for more than one kind of antibody at the same time. A typical blood panel tests for multiple antigens which may elicit an immune response from a subject. The process of using manual methods to resolve panels having multiple antigens is a tedious and time-consuming task.

Antigen data manually entered into electronic systems is not verified for accuracy, nor is data security adequately addressed.

Thus, a need exists for a computerized system and method which electronically obtains, stores, protects, and verifies panels for blood samples with an accompanying high degree of accuracy and speed. In addition, a need exists for a computerized system and method which is cost-efficient to implement and effective across various differing panels.

### SUMMARY OF THE INVENTION

In one embodiment, the present invention is a computer-implemented method of verifying data from an electronic blood screen panel, comprising extracting blood screening data from the electronic blood screen panel into a first data summary, the first data summary including a lot number and expiration date, a donor number, and a number of negative reactions in each row and column in the panel, querying a user to manually enter a second data summary, the second data summary including the lot number and expiration date, the donor number, and the number of negative reactions in each row and column in the panel, comparing the first and second data summaries, and generating a first security code according to an algorithm based on current blood screening data incorporated into the first data summary, the first security code appended to the electronic blood screen panel in the event that the first and second data summaries match.

In another embodiment, the present invention is a computer-implemented method of verifying data from an electronic blood screen panel, comprising extracting blood screening data from the electronic blood screen panel into a first data summary, the first data summary including a lot number and expiration date, a donor number, and a number of negative reactions in each row and column in the panel, querying a user to manually enter a second data summary, the second data summary including the lot number and expiration date, the donor number, and the number of negative reactions in each row and column in the panel, comparing the first and second data summaries, generating a first security code according to an algorithm based on current blood screening data incorporated into the first data summary, the first security code appended to the electronic blood screen panel in the event that the first and second data summaries match, wherein if the first and second data summaries do not match, generating an error message identifying a data component of the first and second data summaries not in agreement, and, upon the initiation of another embodiment of the computer-implemented method, loading the first data summary into memory, generating a second security code according to the algorithm, and comparing the first security code appended to the electronic blood screen panel with the second security code, wherein if the first and second security codes do not match, blocking access to a user.

In still another embodiment, the present invention is an computer program product for verifying data from an electronic blood screen panel, including a computer usable medium having a computer readable program code embodied therein, comprising computer readable program code which extracts blood screening data from the electronic blood screen panel into a first data summary, the first data summary including a lot number and expiration date, a donor number, and a number of negative reactions in each row and column in the panel, computer readable program code which queries a user to manually enter a second data summary, the second data summary including the lot number and expiration date, the donor number, and the number of negative reactions in each row and column in the panel, computer readable program code which compares the first and second data summaries, and computer readable program code which generates a first security code according to an algorithm based on current blood screening data incorporated into the first data summary, the first security code appended to the electronic blood screen panel in the event that the first and second data summaries match.

### BRIEF DESCRIPTION OF THE DRAWINGS

FIG. 1 illustrates an example computer system with processing and networking components for implementing the present invention;

FIG. 2 illustrates a first example graphical user interface (GUI) screen of an electronic blood screen panel;

FIG. 3 illustrates a second example graphical user interface (GUI) screen of an electronic blood screen panel;

FIG. 4 illustrates a third example graphical user interface (GUI) screen of an electronic blood screen panel;

FIG. 5 illustrates an example method of verifying electronic blood screen data; and

FIG. 6 illustrates an example method of verifying electronic blood screen data which can occur in a subsequent opening of an electronic a blood screen panel.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The schematic flow chart diagrams included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

A computer-implemented system and method of checking and verifying blood screening data can serve to solve the problems which have been outlined above.

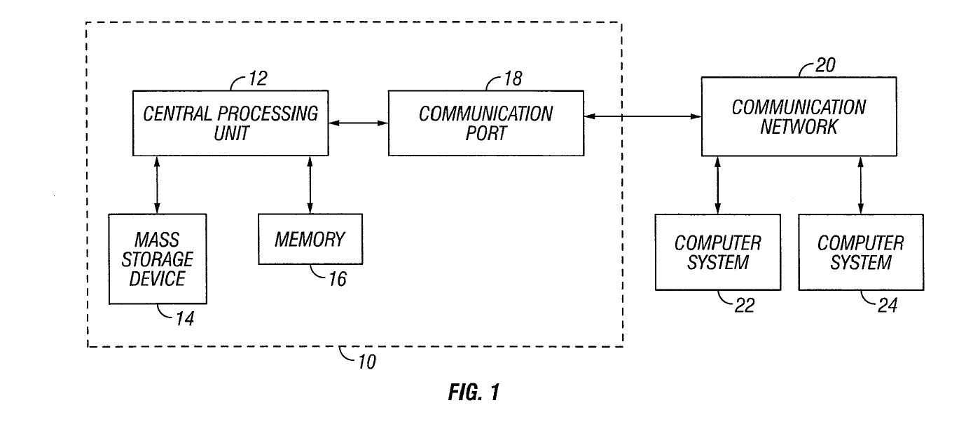

Turning to FIG. 1, an example computer system for implementing the present invention is depicted. System 10 includes a central processing unit (CPU) 12, which is connected by a signal bearing medium to a mass storage device 14 such as a hard disk drive or similar nonvolatile memory. CPU 12 is also connected to memory 16, which can include such memory devices as flash memory. A communication port 18 connects CPU 12 to a communication network 20, which is depicted external to system 10 in a wide-area-network (WAN) configuration, although the network 20 can include such internal network topologies as local area networks (LANs). Finally, computer system 10 is depicted linked to remote computer systems 22, 24 via communication network 20. The methods described herein can execute on one or more computer systems 10, 22, 24, or elsewhere using hardware described, software or firmware compatible with such hardware, or a combination of hardware, software and firmware components.

For example, the methods described herein can execute using such commonly used software platforms as Windows® or Linux. The methods can be implemented with such software applications as Java®. The methods can be embodied in a computer program product including a computer readable medium having programmable instructions executable on systems 10, 22, 24 or elsewhere. The computer program product can be delivered to systems 10 via remote access, over communication network 20 in mediums such as the world-wide-web (WWW), or from remote servers 22 to local workstations 10 over a proprietary or private network 20. Updates to system 10 can be received over network 20.

In addition, system 10 can include portable, handheld devices such as cellular phones, laptop computers, personal desktop assistant devices (PDAs), Blackberry® devices, and the like. The signal bearing medium connecting system 10 with the communication network can be wireless in nature, such as an 802.11 (a)-(n) wireless communications protocol or similar. As a result, a health care practitioner can receive the flexibility to perform blood screen panel work in a variety of locations and situations.

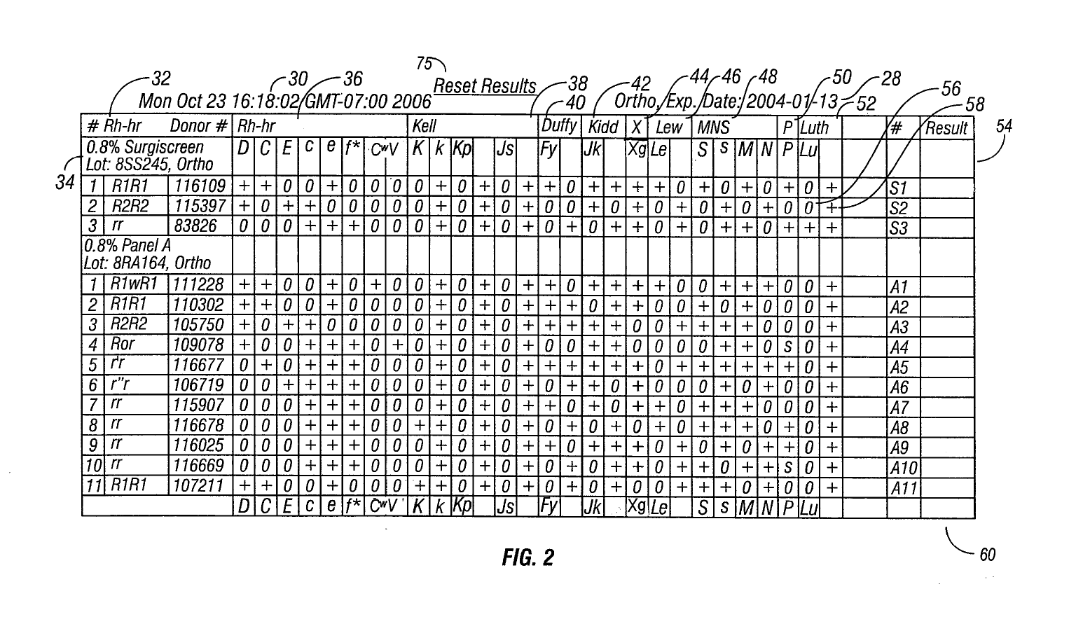

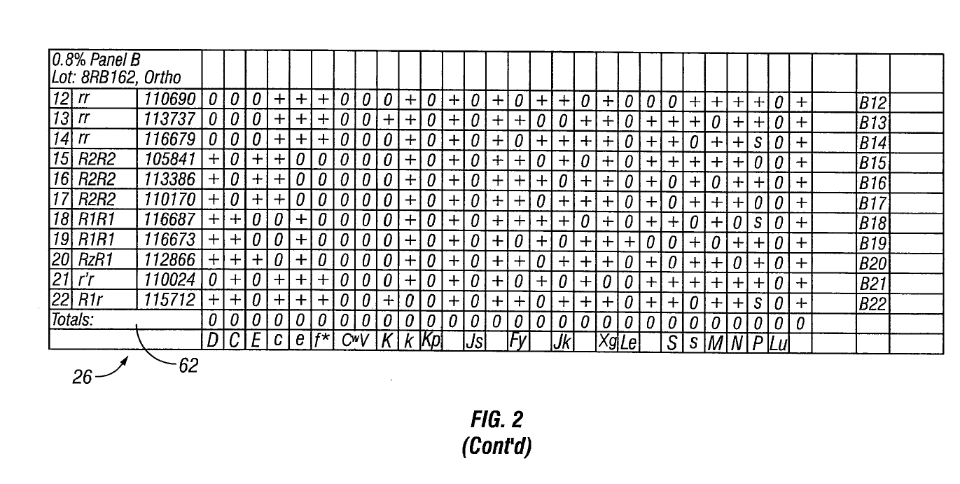

Turning to FIG. 2, a first example graphical user interface (GUI) of an electronic blood screen panel 26 is depicted. Blood screen panel 26 is intended to mimic the paper-based blood screen panels which are commonly in use. As a preliminary matter, the manufacturer and expiration date 28 are identified at the top right. A time and date stamp 30 is seen which is taken from the system 10 time and updates at each mouse click. An Rh-hr blood group and individual donor number column 32 is seen below the time/date stamp 30. An example Ortho® panel 34 with a respective lot number is seen below the Rh-hr title 32. Each panel 34 is organized according to various blood antigen groups, again as is the paper based panel. Rh-hr group 36 is seen, followed by Kell 38, Duffy 40, Kidd 42, X 44, Lew 46, MNS 48, P 50 and Luth 52. The various antigens 54 are seen juxtaposed below the respective groups. Antigens which have “a” and “b” alleles are listed only by the antigen name. Thus, Kp is listed only for the “a” allele. The blank space to the right of Kp is the “b” allele. Omitting the “a” and “b” allows the listing across the top of the panels to be more legible by a reader. Donor antigen data, as determined by the reagent manufacturer, is displayed throughout the panel 26 grid and is either a “0” 56 or a “+” 58.

As is seen, panel 26 reflects a paper-based panel. The rows and columns are similar and in the same order as a printed panel sheet. A practitioner enters results in panel 26 on the right side of the panel, in the Result column 60. For example a practitioner can move a mouse icon over to a respective cell in the column 60, click once to enter a positive result (+), and click twice to enter a negative result (0). If desired, a user can click a third time to remove any results just entered.

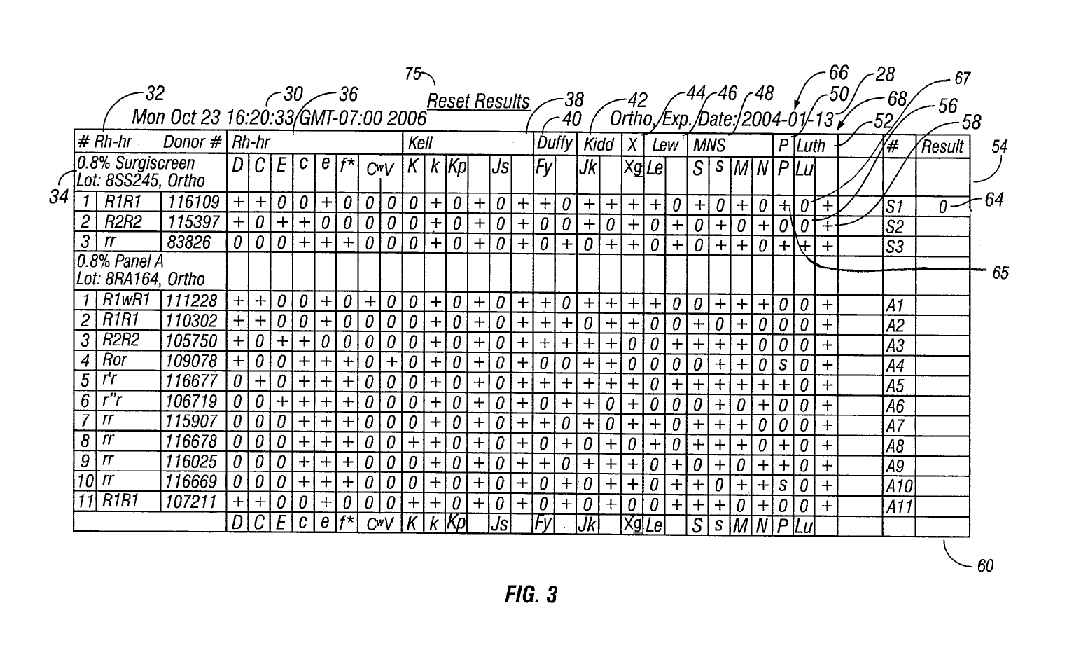

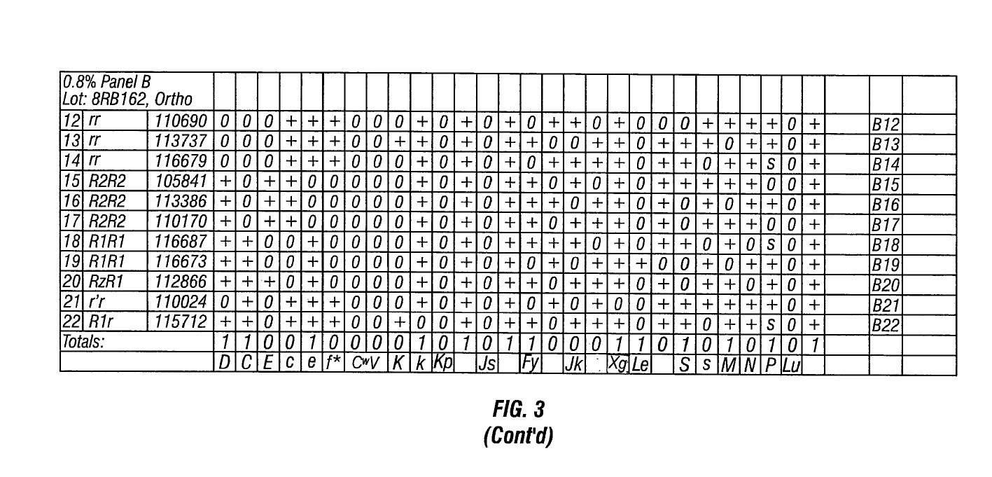

Turning to FIG. 3, a practitioner continues to enter results. Columns having (+) antigens 58 with negative results (0) 56 are ruled out, and change from default gray to white. This process is illustrated for a single antigen only. A practitioner has entered a negative result (0) in cell 64. Because the “P” antigen is (+) 65, the P antibody is ruled out, and column 66 is changed from gray to white. The Lua antigen adjacent to column 66 is (0) 67 and remains unchanged. As more negative test results are entered, more and more columns change from gray to white.

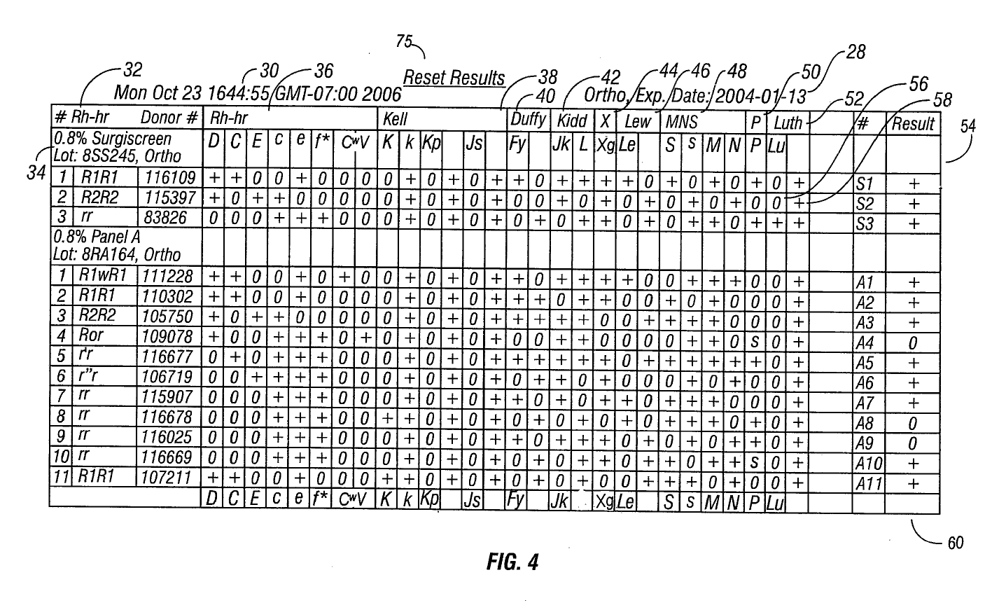

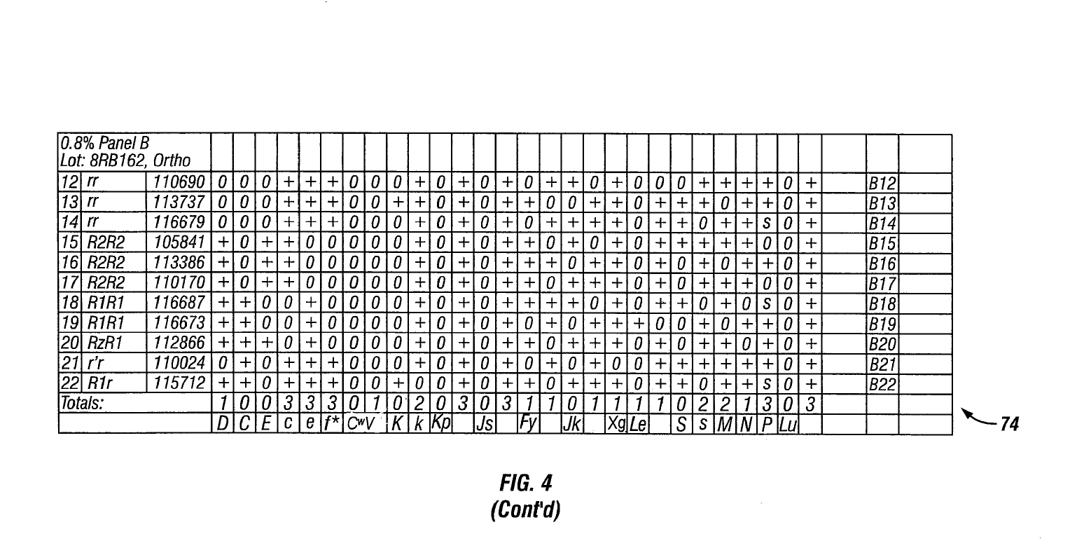

Turning to FIG. 4, the GUI indicates that a practitioner has continued to enter results along column 60. The totals row 74 near the bottom of the panels keeps track of the number of times an antibody has been ruled out. In one embodiment, the totals row is color coded to call attention to those antibodies needing additional testing. A practitioner can click the “Reset Results” icon 75 to return the entire panel 26 to the initial starting condition. A practitioner can use Reset Results 75 when finished with one antibody identification and ready to begin another identification.

A computer-implemented method executed on system 10 can verify the accuracy of practitioner-inputted data. The method can confirm the data to an extremely high degree of accuracy. For example, in one embodiment following computer verification, the chance a panel contains undetected incorrect information is less than one in 3,200,000, or one in 7,700,000, depending on manufacturer. The chance of error can be calculated as follows.

For incorrect data to remain undetected, any single error must have another opposite, or correcting, error in the same row. Two additional errors correcting the first two, must form a rectangle, to total four errors. Thus, for the following, a defined binomial coefficient C(n,k), representing the number of ways to choose k items from a collection of n objects:

C(n,k)=n!/(k!(n−k)!) (1)

where n!=n*(n−1)*(n−2)* . . . *3*2*1, and

k! and (n−k)! are defined likewise.

Consider the following Example A, using Ortho® antigen panels having twenty-five (25) donors with twenty-eight (28) antigens each, the possible number of different vertical pairs for a rectangle having 28 antigen columns with 2 sides is:

$$\begin{matrix}C ( 28 , 2 ) = 28 ! / ( 2 ! ( 28 - 2 ) ! ) \\ = 28 ( 27 / 2 ) \\ = 378 ,\end{matrix} \qquad ( 2 )$$

and the number of different horizontal pairs for a rectangle having 25 antigen rows with two sides is:

$$\begin{matrix}C ( 25 , 2 ) = 25 ! / ( 2 ! ( 25 - 2 ) ! ) \\ = 25 ( 24 / 2 ) = 300.\end{matrix} \qquad ( 3 )$$

Thus, 378*300=113,400 possible rectangles. Additionally, the number of antigen entries [28*25=700 entries] taken with the number of ways to make four errors out of 700 entries is

$$\begin{matrix}C ( 700 , 4 ) = 700 ! / ( 4 ! ( 700 - 4 ) ! ) \\ = 700 * 699 * 698 * 697 / ( 4 * 3 * 2 * 1 ) \\ = 9 \text{,} 918 \text{,} 641 \text{,} 075.\end{matrix} \qquad ( 4 )$$

Given that four errors have been made, the probability those errors are in the shape of a rectangle is

$$\frac{113 \text{,} 400}{9 \text{,} 918 \text{,} 641 \text{,} 075} \qquad ( 5 )$$

which is approximately equal to ˜ 1/87,466.

For any error, the type of the first error fixes the types of the other three errors (because they must undo that error). For each of the three fixed error types, the chance of the error undoing the previous error is ½ (data is a “0” OR “+,w, or s”). Therefore, the chance of 4 errors in a rectangle canceling each other out is

= 1/87,466*½*½*½or˜ 1/699,728. (6)

This assumes four errors are made. The probability of making x errors, with mean number of errors y, is a Poisson distribution (a consequence of probability theory—the “law of rare events”), and is defined by:

ê{−y}*ŷx/x! (7)

where e˜2.71828
x=number of errors made, and
y=mean number of errors each update.
   Generally, a practiced technician can enter a panel with a mean of 2 errors, so the probability of actually making 4 errors would be

ê{−2}*(2̂4)/4!ê{−2}*(⅔)˜ 1/11, (8)

and the probability of making four errors arranged so that they are undetected is

1/11* 1/699,728or˜ 1/7,700,000. (9)

Consider the following Example B utilizing the calculation techniques shown in equations (1)-(9), using Immucor® antigen panels having sixteen (16) donors with twenty-eight (28) antigens each. Again, the number of different vertical pairs for a rectangle=C(28,2)=378. The number of different horizontal pairs (16 antigen rows)=C(16,2)=120. The number of possible rectangles=378*120=45,360. The number of antigen entries=16*28=448. The number of ways to make four errors=C(448,4)=1,656,033,680. The probability in which those errors are in a rectangle= 1/36,509. The probability of 4 errors in a rectangle actually occurring= 1/36,509*½*½*½= 1/292,069. Finally, the probability of four errors arranged so that they are undetected= 1/11* 1/292,069, ˜ 1/3,200,000.

Once the data has been confirmed by system 10, security precautions can be taken by system 10 to ensure that the data remains protected. Once the data has been entered by a practitioner, an electronic extraction of the data can be made which is saved as a security measure. Such a file can be known as a data summary. The data summary can include, but is not necessarily limited to, the expiration date, respective lot numbers, and/or the number of negative (“0”) reactions in each row and column.

Once a data summary has been created, then a practitioner can be queried to manually enter pieces of information from a respective panel to make a determination whether the panel data was entered correctly. Generally, the pieces of information are reflective of the information summarized in the data summary, including again, lot numbers and expiration dates, and/or the number of reactions (positive or negative) in each row and column. Such information can be summarized in a second data summary which can be saved into memory, such as devices 14 or 16 in system 10.

System 10 can then move to compare the first and second data summaries. If the summaries do not match, system 10 can generate an error message and also indicate where the discrepancy is occurring to the practitioner. For example, specific rows and/or columns may be indicated, or a date or lot number.

If the first and second summaries match, then system 10 can generate a security code which is can take into account certain identification information which is unique to a particular panel. System 10 can use algorithms based on the identification information to generate the security code.

Consider an example Security Code C, following. Again, the identifying elements may include additional information, or lesser information, depending on a particular situation or application. Once generated, the security code can be physically appended to a data file to provide for greater security. Appending the code can be performed automatically, as per one embodiment, or can be performed manually with the assistance of a practitioner. Security Code C can consist of a four-line verification code which includes the following:
Line 1 verifier's name and position, the current time, and date
Line 2. a. check digits for each donor number b. check digit for all donor number digits above in “a” c. check digit for the donor numbers and donor number digits in “a” and “b” d. check digit for the Screen Cell lot number
Line 3. a. check digit for the “0” count for each row b. check digit for the numbers above in “a” c. check digit for lot A d. check digit for lot B e. check digit for the expiration date
Line 4. a. check digit for “0” count for each column b. check digit for the numbers above in “a”

Each time system 10 initializes a blood screen application for a particular practitioner, system 10 can perform the steps of reading the data file, extracting the security information to form an additional, or third data summary. A second security code can then be generated from the third data summary. This second security code can then be compared against the first security code appended to the data file. If the file has been changed in any way, the calculated code does not match the pasted code. System 10 can then generate an error message, and disable access to the system and/or the blood screen application by a practitioner.

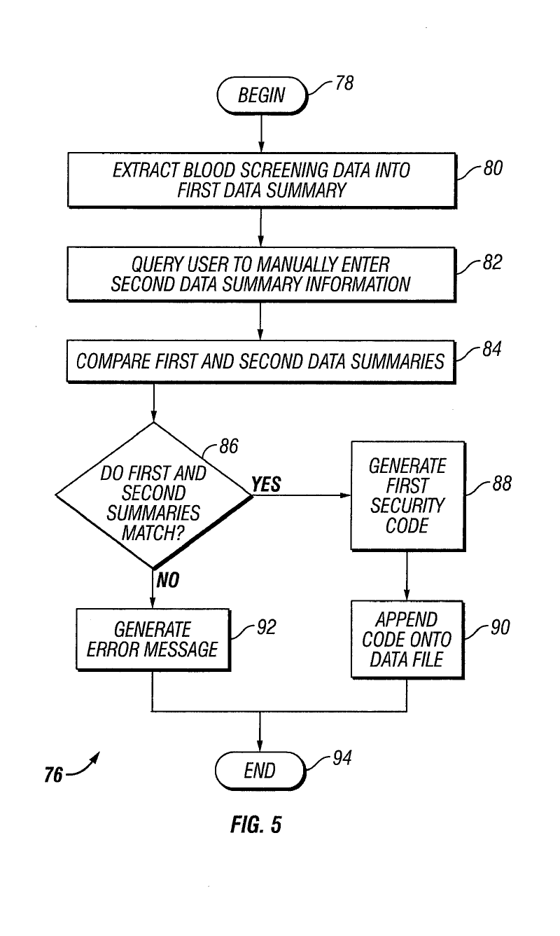

Turning to FIG. 5, an example method of implementing the verification steps previously described is depicted, according to the present invention. Method 76 begins (step 78) by first, extracting the electronic blood screening data into a first data summary as described (step 80). The system 10 then queries a practitioner to manually enter certain information to form a second data summary (step 82). Again, the information can include generally the same information extracted in step 80.

As a next step, system 10 compares the first and second data summaries (step 84). If the summaries match (step 86), then a first security code is generated (step 88) which is appended onto the data file (step 90). If the summaries do not match, an error message is generated, indicating the discrepancy to the practitioner as previously described (step 92). The method 76 then ends (step 94).

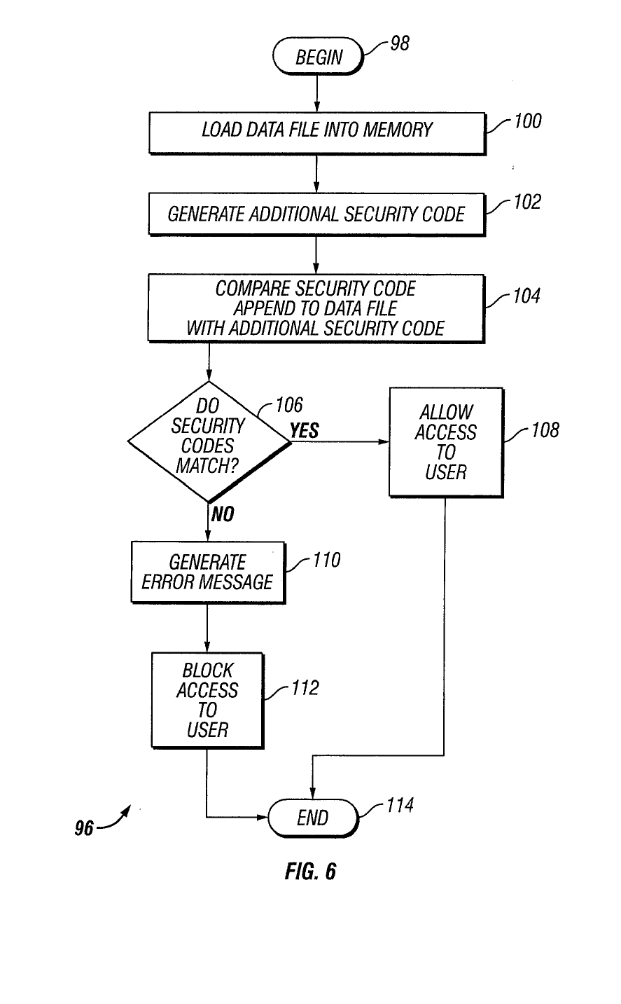

FIG. 6 illustrates an example method of verifying electronic blood screen data which can occur in a subsequent opening of an electronic a blood screen panel. As a first step, method 96 begins (step 98) by loading the saved electronic data file into memory (step 100). Certain information is then again extracted and summarized in a third data summary, and a second security code is generated based on the third data summary (step 102). The second security code is then compared against the first security code appended to the data file (step 104). If the security codes match (step 106), then system 10 re-allows access to the practitioner (step 108). If the security codes do not match, then the system 10 generates an error message (step 110), and proceeds to disable any access the practitioner may have to the data (step 112). The method 96 then ends (step 114).

The foregoing computer implemented methods can provide a powerful, accurate, effective, and depending on the scenario, mobile mechanism for a practitioner to enter blood screen information electronically, while ensuring that the data remains accurate and physically secure.

While one or more embodiments of the present invention have been illustrated in detail, the skilled artisan will appreciate that modifications and adaptations to those embodiments may be made without departing from the scope of the present invention as set forth in the following claims.

What is claimed is:

1. A computer-implemented method of verifying data from an electronic blood screen panel, comprising:
extracting blood screening data from the electronic blood screen panel into a first data summary, the first data summary including a lot number and expiration date, a donor number, and a number of negative reactions in each row and column in the panel;
querying a user to manually enter a second data summary, the second data summary including the lot number and expiration date, the donor number, and the number of negative reactions in each row and column in the panel;
comparing the first and second data summaries; and
generating a first security code according to an algorithm when the first and second data summaries match, based on current blood screening data incorporated into the first data summary, and the first security code appended to the electronic blood screen panel

2. The method of claim 1, wherein if the first and second data summaries do not match, generating an error message identifying a data component of the first and second data summaries not in agreement.

3. The method of claim 1, wherein the first security code includes a representation of a user's name and position, the current time, and the current date.

4. The method of claim 3, wherein the first security code further includes a representation of a donor number.

5. The method of claim 4, wherein the first security code further includes a representation of a lot number.

6. The method of claim 5, wherein the first security code further includes a representation of an expiration date.

7. The method of claim 6, wherein the first security code further includes a representation of a number of negative reactions in a column of the electronic blood screen panel.

8. The method of claim 6, wherein the first security code further includes a representation of a number of negative reactions in a row of the electronic blood screen panel.

9. The method of claim 1, further including, upon the initiation of a second execution of the computer-implemented method, loading the first data summary into memory, and generating a second security code according to the algorithm based on current blood screening data incorporated into the first data summary.

10. The method of claim 9, further including comparing the first security code appended to the electronic blood screen panel with the second security code, wherein if the first and second security codes do not match, blocking access to a user.

11. A computer-implemented method of verifying data from an electronic blood screen panel, comprising:
extracting blood screening data from the electronic blood screen panel into a first data summary, the first data summary including a lot number and expiration date, a donor number, and a number of negative reactions in each row and column in the panel;
querying a user to manually enter a second data summary, the second data summary including the lot number and expiration date, the donor number, and the number of negative reactions in each row and column in the panel;
comparing the first and second data summaries;
generating a first security code according to an algorithm based on current blood screening data incorporated into the first data summary, the first security code appended to the electronic blood screen panel in the event that the first and second data summaries match, wherein if the first and second data summaries do not match, generating an error message identifying a data component of the first and second data summaries not in agreement; and, upon the initiation of a second execution of the computer-implemented method
loading the first data summary into memory,
generating a second security code according to the algorithm, and comparing the first security code appended to the electronic blood screen panel with the second security code, wherein if the first and second security codes do not match, blocking access to a user.

12. The method of claim 11, wherein the first security code includes a representation of a user's name and position, the current time, and the current date.

13. The method of claim 12, wherein the first security code further includes a representation of a donor number.

14. The method of claim 13, wherein the code further includes a representation of a lot number.

15. The method of claim 14, wherein the code further includes a representation of an expiration date.

16. The method of claim 15, wherein the code further includes a representation of a number of negative reactions in a column of the electronic blood screen panel.

17. The method of claim 15, wherein the code further includes a representation of a number of negative reactions in a row of the electronic blood screen panel.

18. A computer program product for verifying data from an electronic blood screen panel, including a computer usable medium having a computer readable program code embodied therein, comprising:
computer readable program code which extracts blood screening data from the electronic blood screen panel into a first data summary, the first data summary including a lot number and expiration date, a donor number, and a number of negative reactions in each row and column in the panel;
computer readable program code which queries a user to manually enter a second data summary, the second data summary including the lot number and expiration date, the donor number, and the number of negative reactions in each row and column in the panel;
computer readable program code which compares the first and second data summaries; and
computer readable program code which generates a first security code according to an algorithm based on current blood screening data incorporated into the first data summary, the first security code appended to the electronic blood screen panel in the event that the first and second data summaries match.

19. The computer program product of claim 18, further including computer readable program code, which, if the first and second data summaries do not match, generates an error message identifying a data component of the first and second data summaries not in agreement.

20. The computer program product of claim 19, further including, computer readable program code which, upon the initiation of a second execution of the computer-implemented method, loads the first data summary into memory, and generates a second security code according to the algorithm based on current blood screening data incorporated into the first data summary.

21. The computer program product of claim 20, further including computer readable program code which compares the first security code appended to the electronic blood screen panel with the second security code, wherein if the first and second security codes do not match, access to a user is blocked.
